(19) United States
(12) Patent Application Publication
(10) Pub. No.: US 2010/0018412 A1
(43) Pub. Date: Jan. 28, 2010

(54) MACHINE FOR PREPARING FOOD

(76) Inventor: Velimir Gruban, Rijeka (HR)

Correspondence Address: Velimir Gruban, Vodovodna 19, Rijeka, 51000, HR

(21) Appl. No.: 12/311,928

(22) PCT Filed: Nov. 8, 2006
(86) PCT No.: PCT/HR2006/000037

§ 371 Date: Mar. 30, 2009

(51) Int. Cl. A47J 43/04

(52) U.S. Cl. 99/357

(57) ABSTRACT

Machine for preparing food consists of a case (1), containers for solid and semi-solid groceries (2), containers for liquid groceries (3), water supply with a heater (4), liquid distributor (5), spice rotor (6), three rotating upper pots with heating plates (7), a rotor with heating plates, which carries the lower pots (8), three lower pots (9), the door opening assembly on the lower pots (10), the control unit (11), water drain (12), cooling system (13), steam exhaust system (14) and machine washing system (15).

### TECHNICAL FIELD

This invention implies a machine for preparing food, classified according to the international classification as: A 47 J Kitchen equipment; Coffee grinders; Spice grinders; Beverage preparation devices; Cooking or heating equipment.

### BACKGROUND ART

The proper daily nutrition of a person includes three basic meals, breakfast, lunch and dinner. Breakfast and dinner usually consist of simple food, while lunch, as the main meal, usually includes three courses: soup, main course and a side-dish. These courses consist of a variety of groceries, the prepraration of which include cooking processes which require a certain amount of time, effort and adequate knowledge on the part of the person who is preparing them. These days, with the increased pace of living, it is not easy to dedicate the required daily amount of time to prepare a complete and high quality meal. Due to this, people often resort to substitutes, which result in inadequate and unhealthy nutrition. This includes the consumption of so-called fast food (pizza, hamburgers etc.), the consumption of food which was cooked a few days before, or the consumption of food in restaurants, the quality of which is often questionable. This manner of nutrition has negatove effects on the human body, causing various medical difficulties.

In view of the current state of technology, stoves, pots, skillets and other kitchen appliances are used for food preparing. All operations, which are required during the food preparation, have to be performed by the person who is preparing the food. There is no device on the market, which would perform these activities instead of that person.

### DISCLOSURE OF THE INVENTION

In the follow-up of the patent registration application, the invention that solves this problem will be explained. The inventions is a device whose purpose is the preparing of food in housholds. The machine is capable of simultaneously preparing three complete courses for several persons. All that the user needs to do is to cut the basic groceries into pieces and put them into the specified containers inside the machine, according to the supplied instructions. Spices and liquid groceries (oil and vinegar) are inside the machine and are periodically refilled (approximately once a week). The water is supplied from the waterworks. The machine performs all the procedures, which are required for the preparation of food. The containers, which hold the groceries, have a cooling system, so the user can place the groceries inside them a few hours before the desired start of the preparation of food. Within the machine, there is a steam exhaust system, which can be connected to the ventilation pipe in the room. The machine also includes a washing system. The washing system is activated after the food preparation cycle is finished and the finished meals are taken out of the machine.

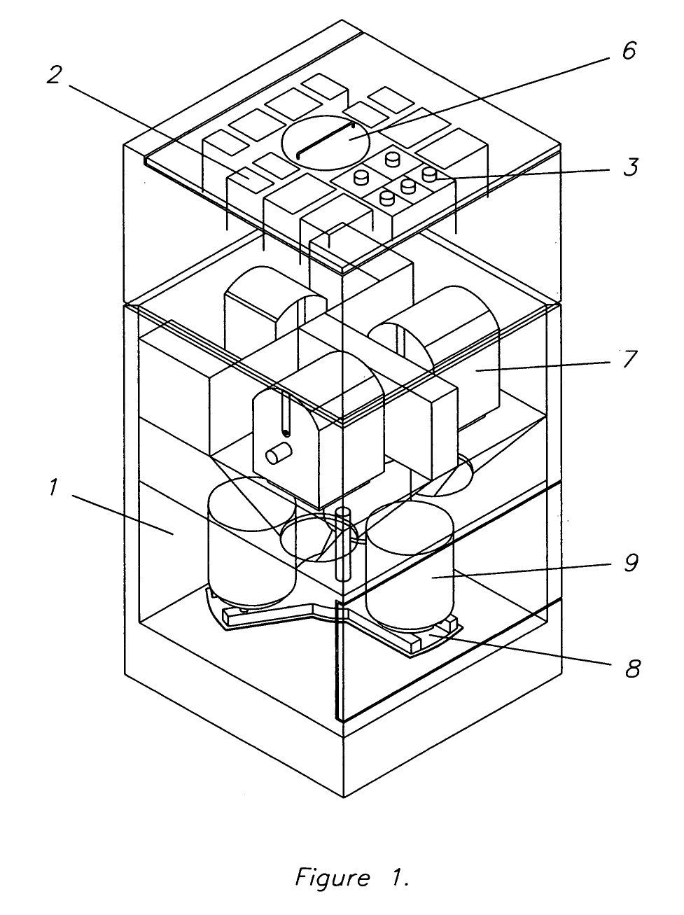

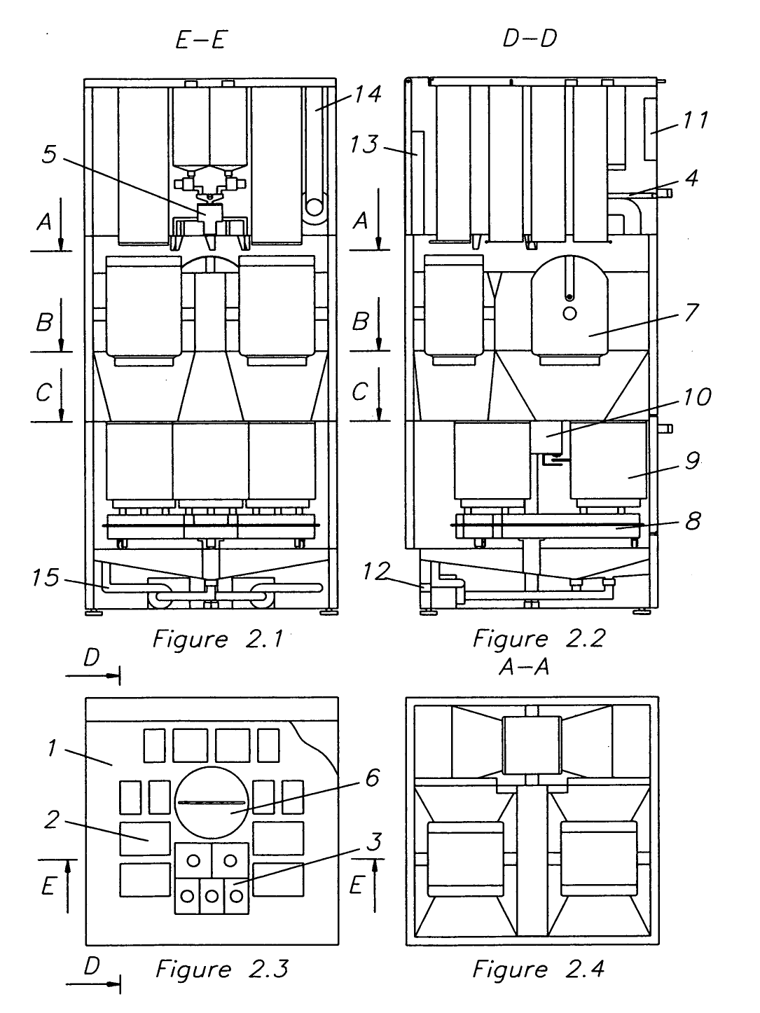

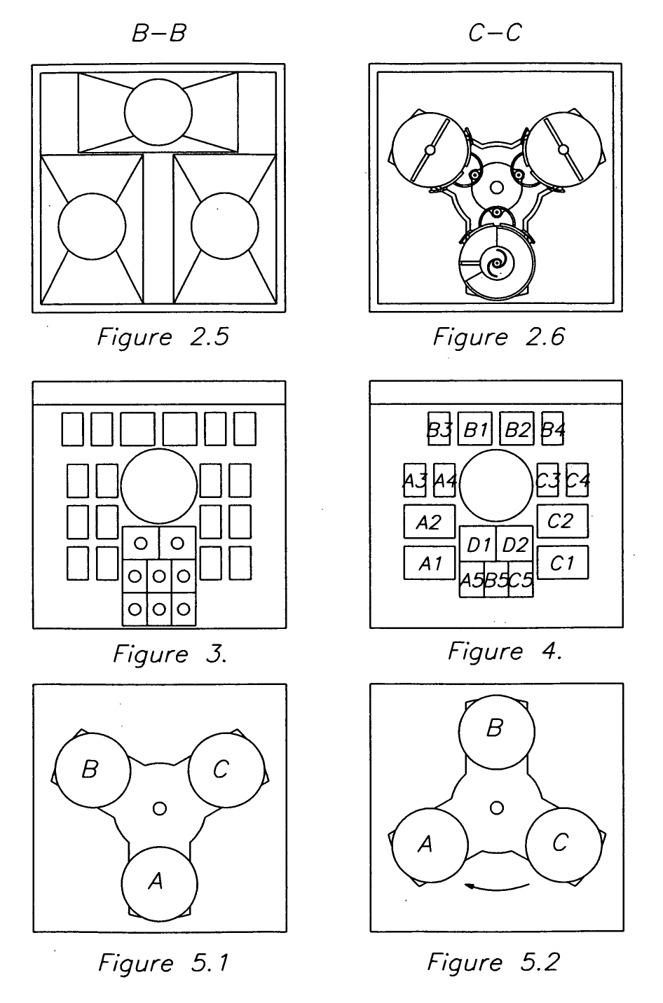

Machine for preparing food, FIG. 1 and FIGS. 2.1-6, consists of the case 1, the containers for solid and semi-solid groceries 2, the containers for liquid groceries 3, the water supply with a heater 4, the liquid distributor 5, the spice rotor 6, three rotating upper pots with heating plates 7, the rotor designed to carry the lower pots, with heating plates, 8, three lower pots 9, the door opening assembly on the lower pots 10, the control unit 11, the water drain 12, the cooling system 13, the steam exhaust system 14, and the washing system 15. The machine includes the three so-called columns. Each column is used for one meal. In the basic version of the machine, FIG. 2.3, one column includes four containers for solid and semi-solid foods, one container for liquid foods, one rotating upper pot and one lover pot positioned on the rotor. The parts which are common to all three columns are the spice rotor, the liquid food containers (for oil and vinegar), the water supply and the liquid distributor. With their aid, all upper and lower pots are filled with spices, oil, vinegar and water. The rotor which carries the lower pots is also common to all columns. The construction machine can be executed with a different number of containers. A version of the machine, with a number of containers which is different from the basic construction version, is displayed on FIG. 3. The machine can include an additional water container, in case the user doesn't have direct access to the waterworks. In that case, he has to fill the machine with water by himself.

Of the four food containers, FIG. 4, two are used to fill the upper pot with groceries (these are marked as 1 and 2, in column A with A1 and A2), and two are used to fill the lower pot with groceries (these are marked with 3 and 4, in column A with A3 and A4). Simple meals consist of a lesser number of groceries, and they are usually prepared in one upper or lower pot. If it is a complex meal, one part of the groceries is thermally processed in the upper pot, while the other is processed in the lower pot, often mixed with rotating whisks. Since the upper pot can rotate even after the thermal processing, it rotates and its contents are dumped into the lower pot. The contents of the two pots are mixed, which results in a complete meal. The control unit controls all machine operations based on a default algorhythm. There is a separate algorhythm for each meal. Instructions, which contain entry numbers for each meal, as well as amounts and types of foods of which the meals are made, and the containers they should be put into, are supplied along with the machine. In the follow-up, the principles of the way the machine works will be explained in detail.

Short description of the figures.

FIG. 1 displays the spatial appearance of the machine. The outer sides of the case are displayed as if they are made of transparent material, so the inner parts can be seen.

FIGS. 2.1-3 display the draft, the ground plan and the body plan of the machine.

FIGS. 2.4-6 display the ground plans in cross-section A-A, B-B and C-C.

FIG. 3 displays an example of a construction version of the machine with a number of containers that is different from the basic version.

FIG. 4 displays the marks of the containers that hold the groceries in the basic version of the machine.

FIG. 5.1 displays the rotor with the lower pots in the starting position, i.e. in the cooking position.

FIG. 5.2 displays the rotor with the lower pots in a turned position, in which the filling of the pots or the dumping of the contents of the upper pots is performed.

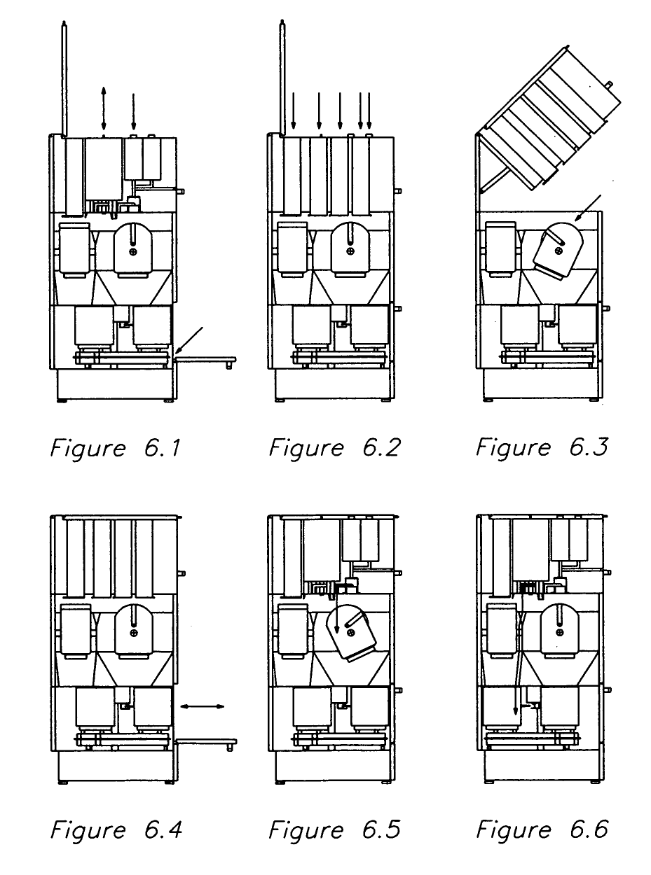

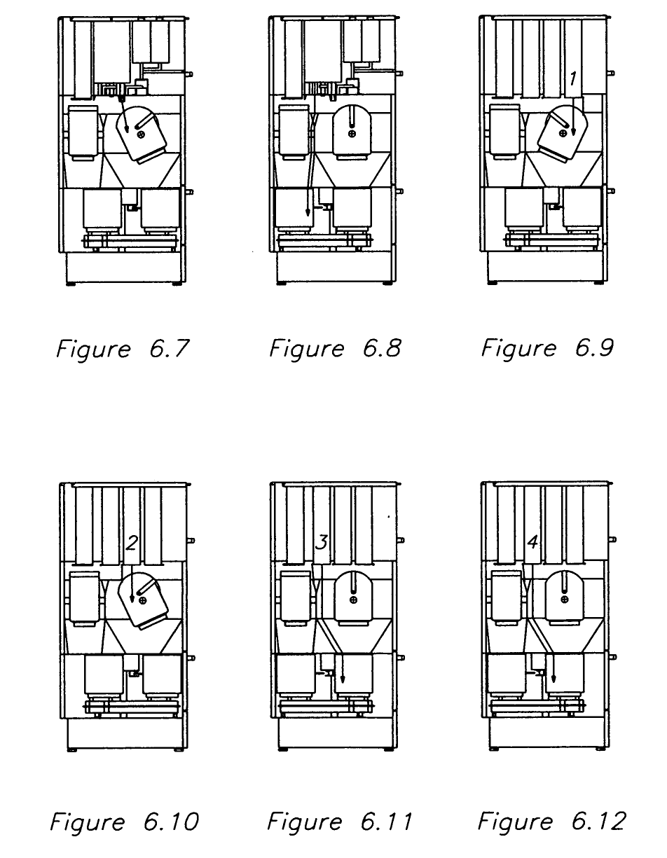

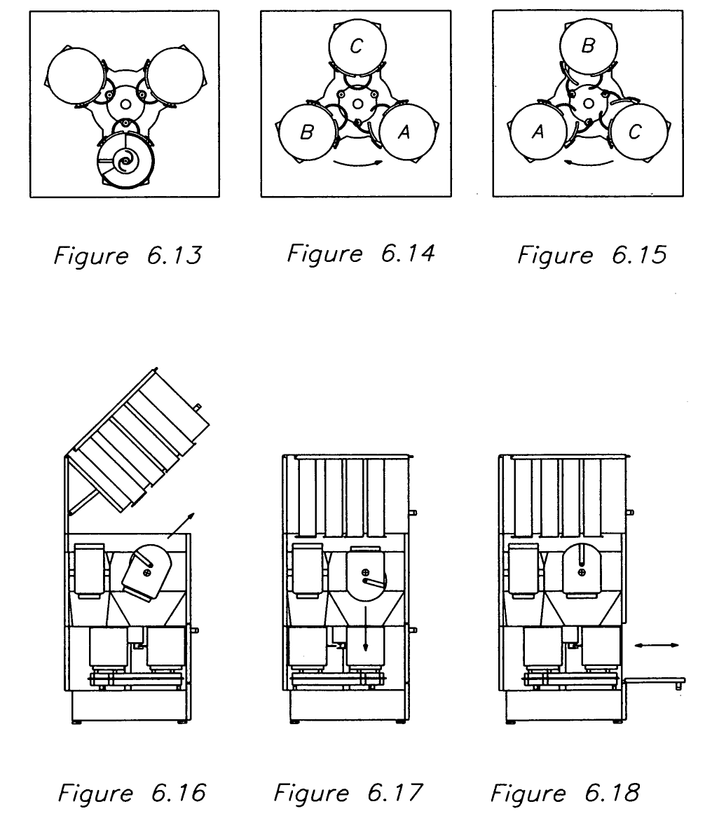

FIGS. 6.1-18 display the basic working operations of the machine.

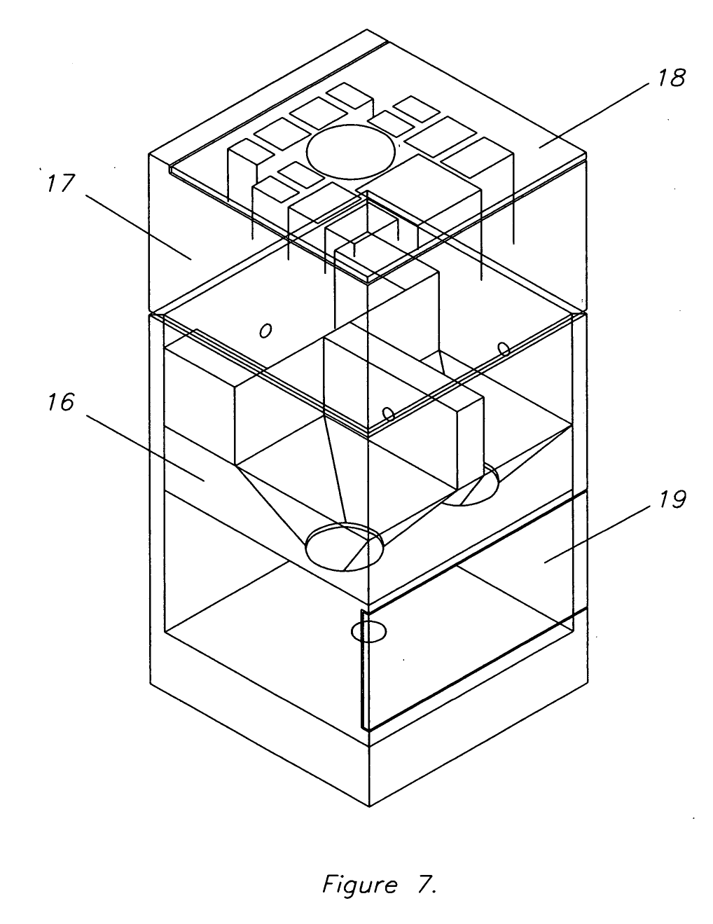

FIG. 7 displays the spatial appearance of the case.

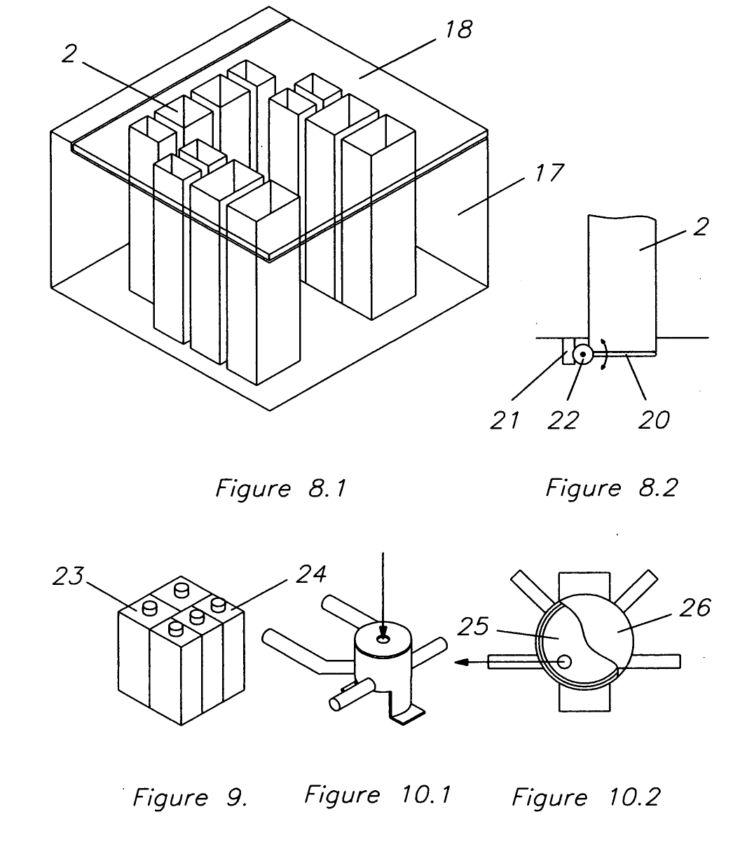

FIG. 8.1 displays the spatial appearance of the containers for solid and semi-solid groceries.

FIG. 8.2 displays the body plan of the the containers for solid and semi-solid groceries.

FIG. 9 displays the spatial appearance of the containers for liquid groceries.

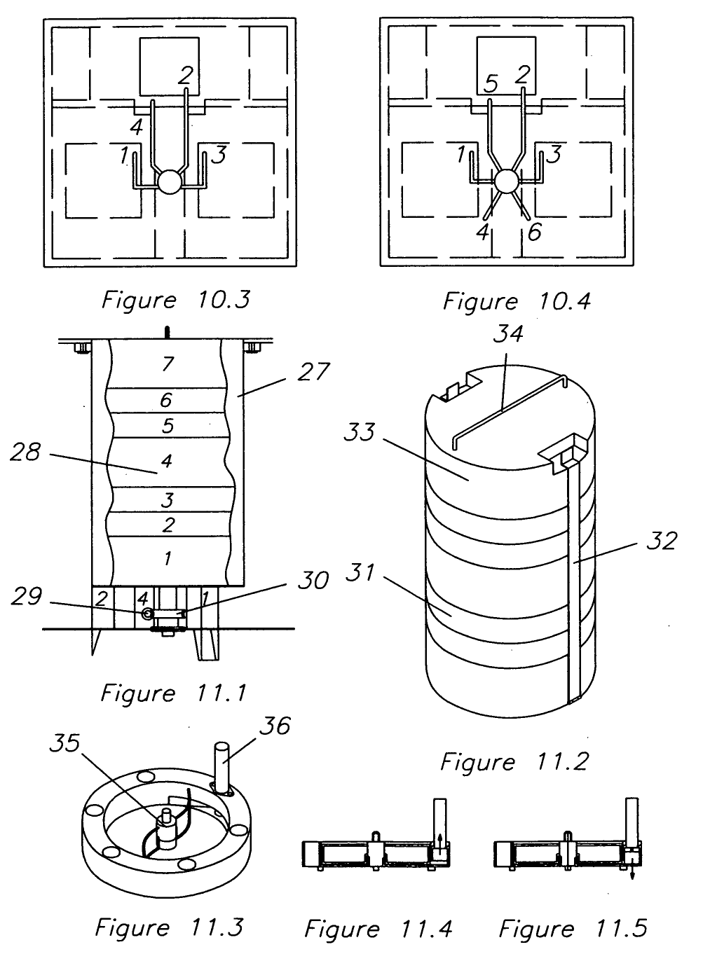

FIG. 10.1 displays the spatial appearance of the liquid distributor.

FIG. 10.2 displays the ground plan of the liquid distributor.

FIG. 10.3 displays the ground plan of the flud distributor and the piping in the basic version.

FIG. 10.4 displays the ground plan of the flud distributor and the piping in an alternative version.

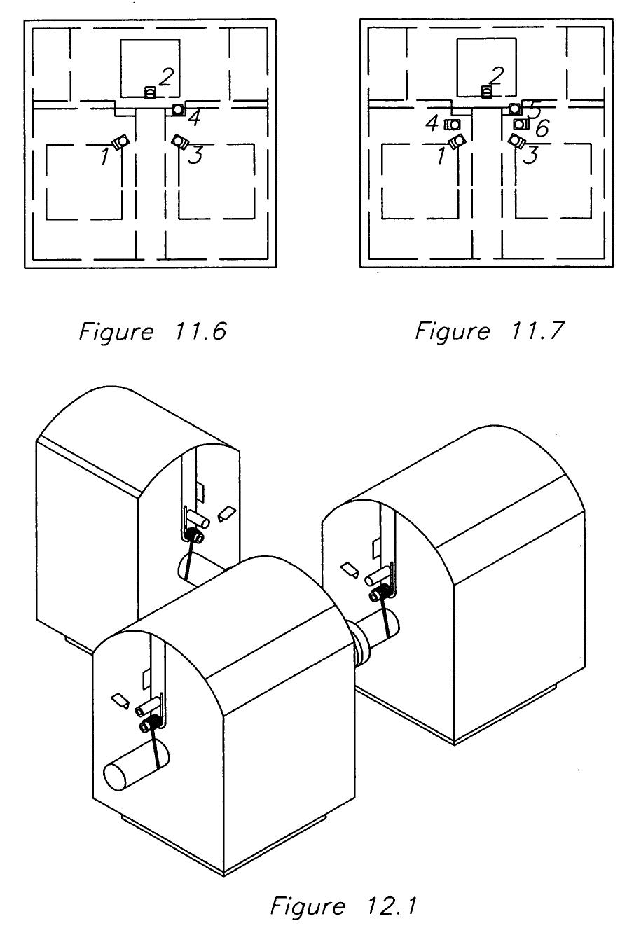

FIG. 11.1 displays the draft of the spice rotor.

FIG. 11.2 displays the spatial appearance of the assembly of the spice containers.

FIG. 11.3 displays the spatial appearance of the spice container.

FIGS. 11.4 and 11.5 display the container in a draft cross-section and the spice dosage principle.

FIG. 11.6 displays the placement of the openings and the sloping paths for the filling of upper and lower pots with spices in the basic version.

FIG. 11.7 displays the placement of the openings and the sloping paths for the filling of upper and lower pots with spices in an alternative version.

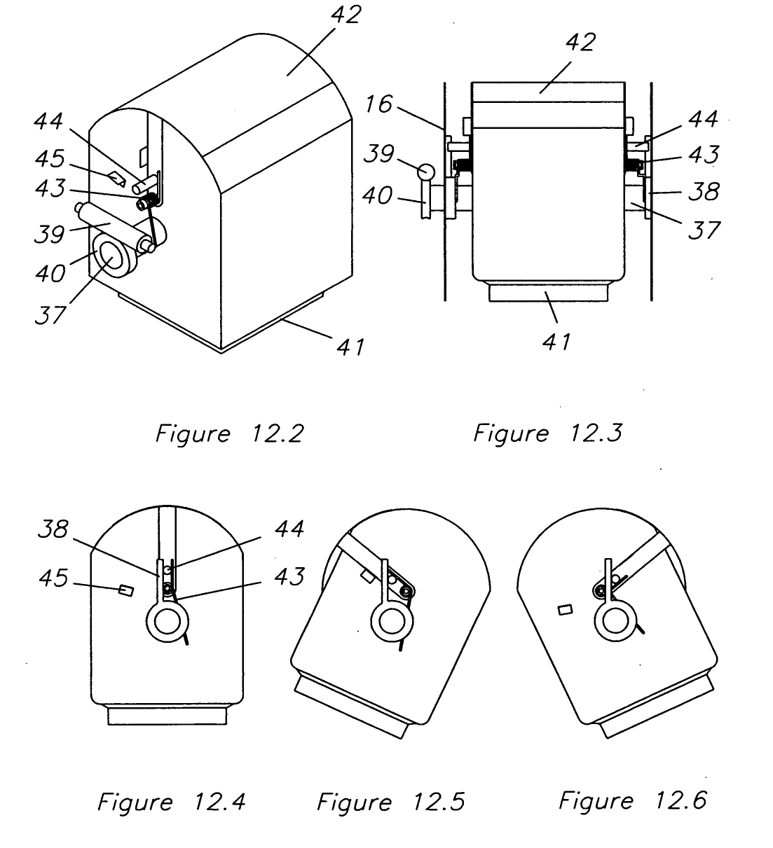

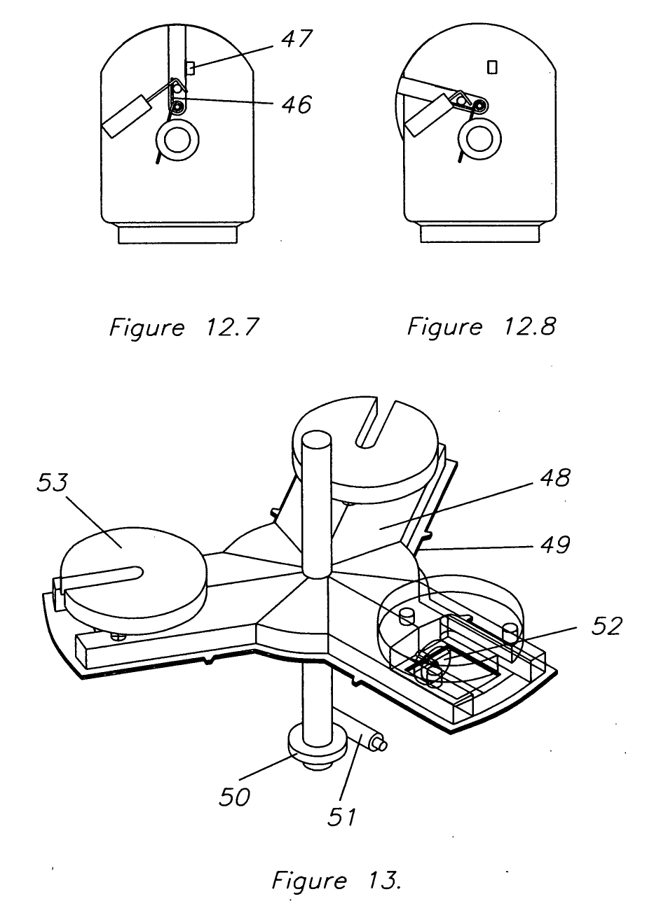

FIG. 12.1 displays the spatial appearence of the upper three pots.

FIG. 12.2 displays the spatial appearence of the lower three pots.

FIG. 12.3 displays the draft of the upper pot.

FIG. 12.4 displays the upper pot in the starting position.

FIG. 12.5 displays the upper pot rotated rotated clockwise, as well as the opening principle of the movable lid on the pot.

FIG. 12.6 display the upper pot rotated counter-clockwise, as well as the opening principle of the movable lid on the pot.

FIGS. 12.7 and 12.8 display the opening principle of the movable lid on the pot in an alternative version.

FIG. 13 displays the spatial appearance of the rotors that carry the lower pots.

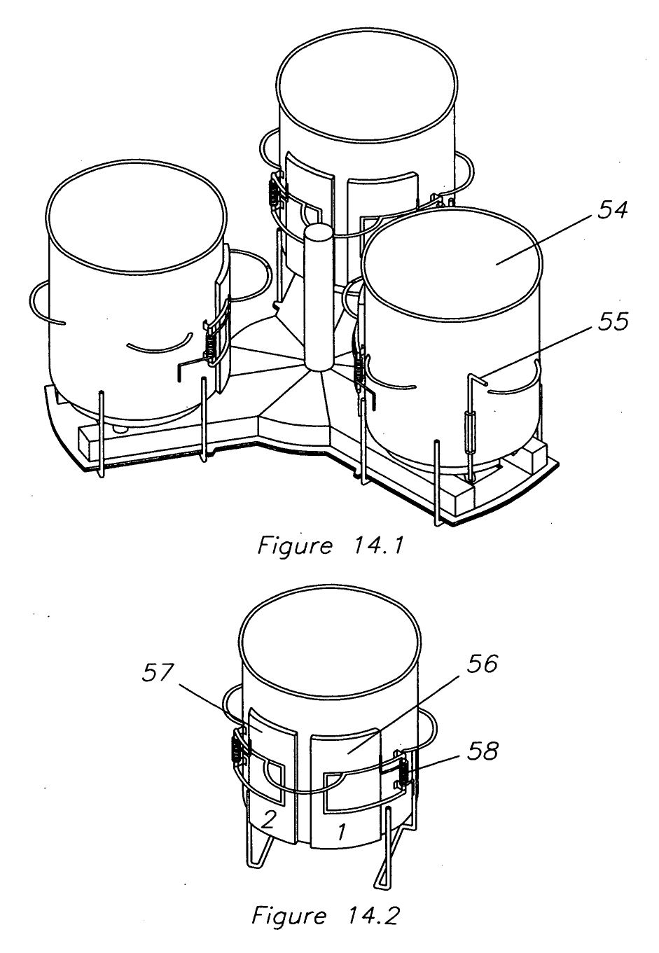

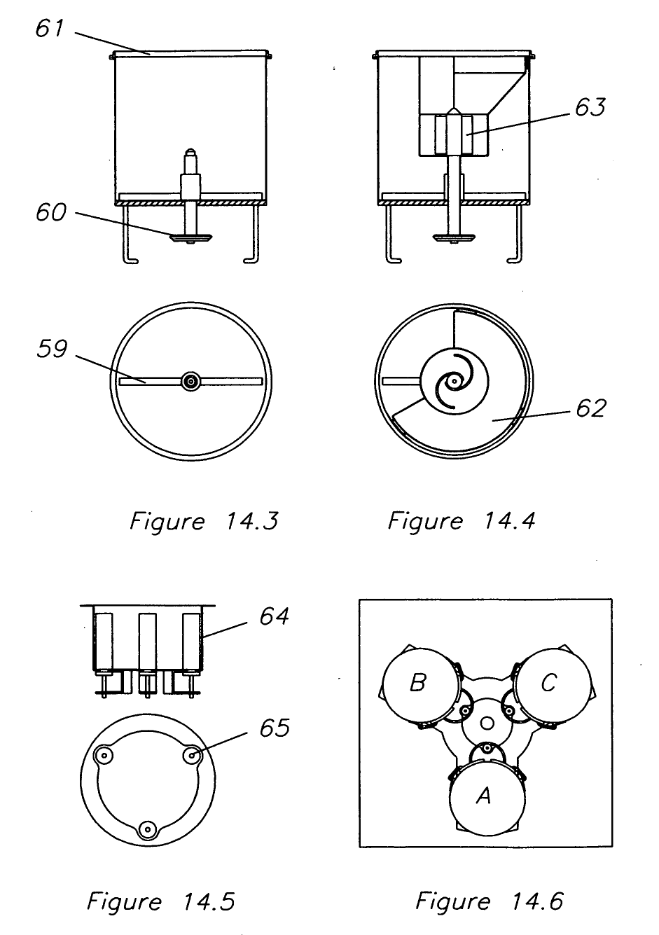

FIG. 14.1 displays the spatial appearance of the three lower pots fastened to the rotor that carries the lower pots.

FIG. 14.2 display the spatial appearance of the lower pot.

FIG. 14.3 displays the draft and the ground plan of the lower pot.

FIG. 14.4 displays the draft and the ground plan of the lower pot in column A.

FIG. 14.5 displays the door opening assembly on the lower pots.

FIGS. 14.6-8 display the door opening principle on the lower pots.

FIG. 15 display the working principle of the cooling system.

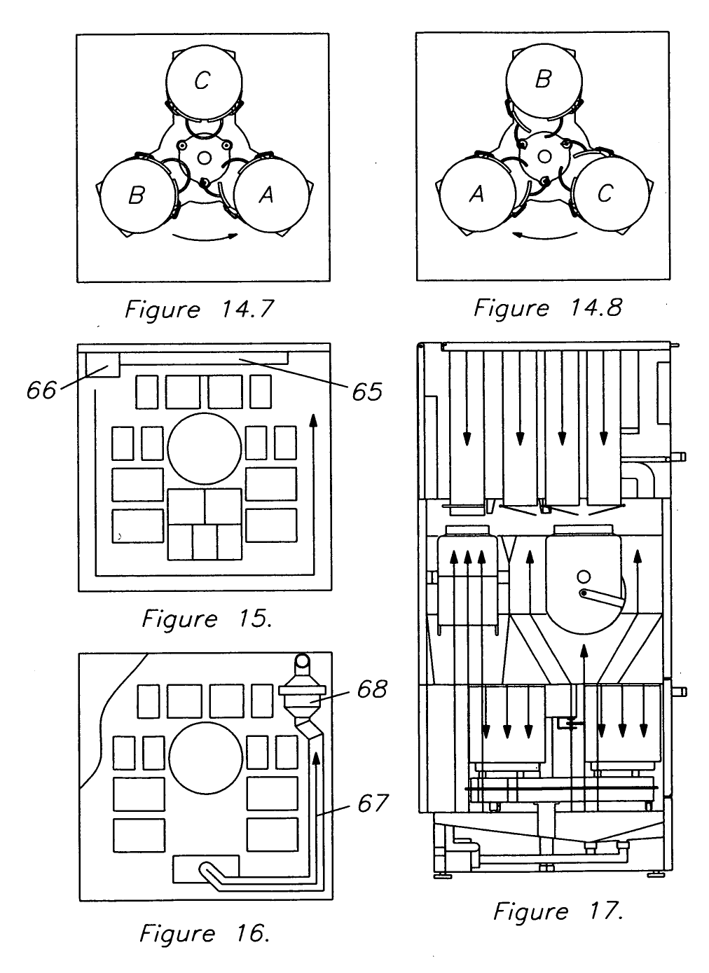

FIG. 16 displays the working principle of the steam exhaust system.

FIG. 17 displays the working principle of the washing system.

In the follow-up, we will explain the working principle of the machine. As it was mentioned before, the machine has three columns, whose purpose is the simultaneous cooking of three foods. The containers and pots in all three columns are labeled with labels, which consist of a combination of letters and numbers (i.e. B3). The letter in the label represents the column in which the container or pot is located. The columns are labeled with the letters A, B and C. The number in the label represents the container or pot of the column in question. The solid and semi-solid groceries containers, FIG. 4, are labeled with the numbers 1-4. The liquid groceries container has the number designation of 5, the upper pot is labeled with 6, while the lower pot is labeled with 7. In other words, B3 represents container number three in column B. The containers which are used for oil and vinegar (labeled with D1 and D2 in the figure) have the names of the groceries written on it. Also, the names of the groceries are written in the rotor of the spice containers labeled with 1-6. The upper pots are in their staring position when they are in a vertical position. FIG. 5.1 displays the lower pots in their starting position, i.e. cooking position while, in the position displayed in 5.2, the pots are either filled with groceries, or the contents of the upper pots are dumped.

In the first part, we will explain the basic working operations of the machine. The basic operations are:

1. Refilling of spices and liquid groceries (oil, vinegar) and washing detergents, FIG. 6.1. Spices and liquid groceries are periodically refilled approximately once a week. The user performs the refill of spiced by lifting the lid of the pots and taking the spice rotor out. He refills the spices and puts the rotor back into the machine. The refill of oil and vinegar is performed by pouring the groceries into the machine. The detergents are put into containers, which are located in the lower part of the case.

2. Filling the containers with groceries, FIG. 6.2. The filling of the machine with groceries is performed before each cooking cycle. The filling can be performed several hours before the cooking process is started. The user lifts the lid and puts solid and semi-solid groceries into containers labeled with the numbers 14. He pours liquid groceries into the container labeled with the number 5. After filling the containers, he lowers the lid.

3. Direct filling of the upper pot with groceries, FIG. 6.3. While preparing some meals, the groceries are directly put into the pot before cooking. The pot is turned for angle φ and the lid should be opened. The user lifts the lid of the machine and puts the groceries directly into the pot. Then he closes the lid, and the pot returns into its starting position.

4. Direct filling of the lower pot with groceries, FIG. 6.4. The required lower pot comes into a position in front of the door of the case through the rotation of the rotor. The user takes the pot out of the machine through the front door on the case of the machine. He fills the pot with groceries and returns it into the machine. After that, the rotor takes its starting position.

5. Direct filling of the upper pot with liquids, FIG. 6.5. The pot is turned for angle −φ. Depending on the pot in question, the rotational distributor directs the liquid towards the pot. When the distributor takes the required position, the electric valve on the container from which the liquid should be filled opens, or the electric valve on the water supply. After the pot fills with the required amount of liquid grocery, the electric valve closes. The water can be either hot or cold. If hot water is used, the throughput heater is engaged. In case of the alternative version, there is no need to rotate the pot.

6. Filling the lower pot with liquids, FIG. 6.6. The rotor with the lower pots is turned, so the lower pot we want to fill comes into the position of the column B. The rotational distributor is set to a position which directs the liquids towards the lower pots. The electric valve opens, on the container from which we want to bring the liquid grocery, or the electric valve of the water supply opens. In case of the alternative version, the rotor with the pots turns for 60 degrees (the pot comes into the position below the opening in the case), and the distributor is set into the required position, depending on the pot in question. The alternative version will be explained later in the explication.

7. Filling the upper pot with spices, FIG. 6.7. The pot is turned for angle −φ. After that, the rotor will turn, so the required spice takes a position above the opening in the case, which leads towards the desired pot. Aided by the whisks and the dosage device on the containers of the spice rotor, the specified amount of spice will be dropped into the pot. After the dosage, the spice rotor and the pot return to their starting positions.

8. Filling the lower pot with spices, FIG. 6.8. The rotor with the lower pots turns, so the pot we wish to fill moves into the position of the B column. The spice rotor rotates for an angle, so the desired spice arrives into a position which leads towards the lower pot. With the aid of the whisks and the dosage device, the appropriate amount of spice is dosed. After the dosage, the rotor with the pots and the spice rotot return to their starting positions. In the case of the alternative version, the rotor with the pots turns for 60 degrees, and the rotor with spices turns so the desired spice arrives above the opening which leads towards the required pot.

9. Filling the upper pot with groceries from container 1, FIG. 6.9. The pot is turned clockwise for angle φ, while the lid of the pot opens. After that, the door of container 1 open and the contents are dumped into the pot. The door of the container closes and resumes a semi-closed position. After the cooking process and the washing process is finished, the door fully closes. The pot returns to the starting position. In the case of the alternative version, it is not necessary to turn the pot, because the pot is opened with the aid of a relay, or there is no lid at all.

10. Filling the upper pot with groceries from container 2, FIG. 6.10. The pot turns counter-clockwise and the lid of the pot opens. The door of container 2 opens and the contents are dumped into the pot. The door of the container resumes a semi-closed position. After the washing, the door fully closes. The pot returns to the starting position. In the case of the alternative version, it is not necessary to turn the pot.

11. Filling the lower pot with groceries from container 3, FIG. 6.11. The rotor with the lower pots turns for 60 degrees from position zero. The lower pot is below the opening in the case. The door of container 3 opens. After the contents of container 3 have been dumped, the door resumes a semi-closed position, and later on, they fully close. The rotor returns to the starting position.

12. Filling the lower pot with groceries from container 4, FIG. 6.12. The rotot turns for 60 degrees. The door on container 4 opens. After the contents of the container have been dumped, the door closes and the rotor returns to the starting position.

13. Heating the upper pot. After the liquids (for example, oil or water) have been dumped into the pot, heating is performed through the heating plate. When the liquid in the pot is heated to the required temperature, the other groceries are dumped into the pot.

14. Heating the lower pot. The liquid in the lower pot is heated through the heating plate, which is placed on the rotor. After that, the other groceries are dumped into the pot.

15. Cooking in the upper pot. The groceries in the pot are cooked through the activity of the heating plate. During the cooking process, the pot is in the starting position.

16. Cooking in the lower pot. The groceries in the pot are cooked through the activity of the heating plate. During the cooking process, the rotor with the pots is in the starting position, i.e. the pots are in the cooking position.

17. Running the vegetables through a stainer, FIG. 6.13. Running the vegetables through a strainer takes place in the lower pot of column A. When the contents of the upper pot is dumped, the vegetables arrive at the strainer, where they have to be run through. The whisks in the circular part of the strainer are activate. With their rotation, the whisks are pressing the vegetables towards the wall of the strainer. The vegetables pass through the hole of the strainer and the straining takes place.

18. Straining the liquid out of the contents of the lower pot, FIG. 6.14. If it is necessary to strain the cooked groceries from the lower pot, we will use door 1. Below them, on the wall of the strainer, there are holes. Let us assume that we need to strain the water out of the pasta. The rotor is in position zero. The relay is activated, i.e. its metal core is lowering. After that, the rotor turns counter-clockwise for 60 degrees. The lever of the door is pitting against the metal core of the relay and the door opens. The liquid is strained through the holes in the wall of the pot. The rotor returns to the starting position and the door closes. After that, the relay goes out, i.e. the metal core withdraws.

19. Draining the liquid out of the lower pot during the washing process, FIG. 6.15. Door 2 on the lower pots is used for the draining of the water during the washing process. Unlike the holes below door 1, there is an opening below door 2. The door is used as an exit for the water and the leftovers of the groceries. The opening of the door begins with the activation of the relay. The rotor turns for 60 degrees clockwise. During this turning, the door opens. After the washing process is finished, the rotor returns to the starting position and the door closes. After that, the relay goes out.

20. Direct unloading of the upper pot, FIG. 6.16. The pot turns for angle φ. The user lifts the lid of the case and takes the meal directly out of the pot. He lowers the lid of the case, and the pot returns to the starting position.

21. Emptying the upper pot, FIG. 6.17. While emptying the pot, it turns for 180 degrees, and the lid of the pot fully opens. The rotor with the lower pots turns for 60 degrees from the starting position. This way, the lower pot arrives under the upper pot. Both pots are part of the same column. With the turning of the upper pot, the dumping of its contents into the lower pot is performed.

22. Emptying the lower pots, FIG. 6.18. The user opens the front door of the machine's case and removes the lower pot of column A. He empties the contents of the pot and returns the pot back into the machine. He pushes a specific button on the keyboard, which rotates the rotor for 120 degrees. The user removes the lower pot of column B, empties the contents and returns the pot back into the machine. He pushes the button on the keyboard again, and the rotor turns for another 120 degrees. The user removes the lower pot of column C, empties the contents and returns the pot back into the machine. He pushes the key once again, and the rotor returns to the starting position.

In the follow-up, we will explain how to prepare characteristic meals and how the machine prepares them. All kinds of soups are prepared in column A, and the cooking of bigger pieces of meat is also performed there. Meals with stewed meat, stewed meat and vegetables, sauces, side dishes and fried meals are prepared an column B. Side dishes and fried meals are prepared in columns B and C, depending on the combination of the foods in question.

Characteristic meals which are being prepared in column A: soups and bigger pieces of meat. There are two basic types of soups: meat soups and browned flour soups.

Meat soups. Meat soups are made with beef, poultry, pork, fish etc. Vegetables (carrots, parsley, celery etc.) are cooked alongside meat, and pasta is usually used as a supplement. Apart from the mentioned groceries, we need water, oil, salt, pepper and spices (to enhance the taste) to prepare such soups.

The basic method to prepare these soups is as follows: The meat, cut into pieces, is dumped into a pot with salted water. The meat is cooked for a specific time, after which the cut vegetables are added into the pot, and then we keep cooking the mixture. In a separate pot, we fry some onion on oil. When the meat and vegetables are cooked, the contents of the pot are dropped and strained into the pot with the fried onions. After that, pasta is cooked in the soup. All spices are added, and the whole mixture is cooked for some additional time. After that, the soup is ready.

Now we will describe the method the machine will use to cook a meat soup. To cook a meat soup, we need groceries: meat, vegetables, onion, pasta, oil, water, salt, pepper and taste-enhancing spices. We put meat into container A1, vegetables into container A2, onion into container A3 and pasta into container A4. The oil is inside the device, the water comes from the water supply, while salt, pepper and taste-enhancing spices are in the spice rotor.

The meat and vegetables will be cooked in the upper pot, while the onions will be fried in the lower pot. Initially, the upper pot will be filled with the required amount of water. Then the spice rotor adds the required amount of salt. After that, container A1 is emptied. The meat from the container is dumped into the pot. The heating of the water begins and the meat starts cooking. After a specific time, container A2, which contains vegetables, is emptied into the pot. After the vegetables are inside the pot, the cooking continues. Before the cooking process is finished, the oil is fried in the lower pot. The lower pot is filled with the required amount of oil. Onions are dumped from container A3 into heated oil, and it is fried for a specific amount of time, while the whisks are constantly mixing. After the thermal processing of the groceries in both pots, the upper pot turns for 180 degrees and the contents of the pot drop onto the strainer, which is located in the lower pot. The meat and the vegetables stay on the strainer, while the liquid is strained into the pot. Pasta is added from container A4 into the strained soup in the lower pot. After the pasta is cooked, taste-enhancing spices and pepper are added from the spice rotor. The whole mixture is cooked for some additional time and the soup is ready.

Browned-flour soups. These soups consist of browned flour, and their most usual supplement are cooked and strained vegetables. The browned flour is made from oil and flour, with the flour being quickly fried in oil, with constant stirring. Depending on the vegetables from which the soup is made, some garlic can be added into the browned flour. After that, water and salt is added and the mixture is cooked for some time. Vegetables are cooked in another pot. After the vegetables are cooked, they are strained and dumped into the pot with the browned flour. Some salt and pepper are added, and the whole is cooked for some additional time. After that, the soup is ready.

Now we will explain the method the machine will use to cook this soup. The required groceries are: vegetables, onions, garlic, water, oil, flour, salt, pepper and taste-enhancing spices. We put the vegetables into container A1, the onion into container A3, and the garlic into container A4. The other groceries are in the machine. The vegetables will be cooked in the upper pot, while the browned flour will be made in the lower pot. Water and salt is poured into the upper pot. Vegetables are dumped from container A1 and cooked for a certain time. The required amount of oil is poured into the lower pot. Then, flour is added, with constant stirring of the whisks. From container A3 comes the onion, and from container A4 the garlic. Both are fried, and then cold water is added. When the vegetables are cooked, the upper pot rotates and drops the vegetables into the lower pot. The contents drop onto the strain. The liquid falls into the lower pot, while the vegetables remain on the strain. The whisks inside the strain rotate and strain the vegetables. The strained vegetables fall into the soup, which is constantly being cooked and stirred. After that, some salt and pepper is added, and the whole mixture is cooked for some more time. The soup is ready.

Bigger pieces of meat, which are supposed to be eaten with sauces and vegetables, are also cooked in column A. Meat is cooked in salted water.

Cooking bigger pieces of meat. The method of cooking bigger pieces of meat in the machine. To cook meat, we need the following groceries: meat, water and salt. The user puts the bigger pieces of meat directly into the upper pot. After that, the machine adds water and salt. Meat is cooked for a specific period of time. After it is cooked, the user takes it directly out of the pot. The liquid in which the meat was cooked is poured into the lower pot. After that, the user takes the lower pot with the liquid out of the machine.

In the follow-up, we will explain how to prepare characteristic meals in column B: stewed meat meals, meals with stewed meat and vegetables, sauces, side dishes and fried meals.

Meals with stewed meat. Stewing is a procedure during which the meat softens under the influence of steam and heat. A characteristic meal with stewed meat is the stew. The stew is made in a single pot. In the beginning, onions are fried in oil. Salt, red peppers and meat cut into pieces are added, and all of it is stewed in its own juice. After a specific period of time, flour is added. When the flour turns yellow, water is poured into the pot, and everything is stewed until it becomes tender. In the end, semi-liquid tomato is added, alongside salt and taste-enhancing spices, and the blend is cooked for some more time.

Now we will explain the method the machine will use to cook the meal. To prepare the stew, we need the following groceries: meat, onions, semi-liquid tomato, oil, water, salt, red peppers, flour, taste-enhancing spices. The onions should be put into container B3, and the meat into container B4. In the container B1, we will put the semi-liquid tomato. The stewing of the meat will take place in the lower pot. Oil is poured into the lower pot and heated. Onions from container B3 are added and constantly stirred by the whisks. After a specific period of time, red peppers are added. From container B4, meat is added. Salt is added. After that, meat is stewing in its own juice. Flour is added. When the flour turns yellow, water is added and the stewing continues until it becomes tender. Eventually, semi-liquid tomato is added from container B1 into the upper pot. The pot turns for 180 degrees and the tomato is dumped into the lower pot. In the end, spices are added and the blend cooks for some more time. The stew is ready.

Meals with stewed meat and vegetables. The next type of meal, which is cooked in column B, are meals made with stewed meat and vegetables. Meat is stewed in the pot as previously described. Vegetables are cooked in a separate pot and mixed with the stewed meat afterwards.

The groceries of which the meal consists are: onions, meat, vegetables, semi-liquid tomato, oil, water, salt, red peppers, flour and taste-enhancing spices. We will put the onions into container B3, the meat into container B4. We will put the vegetables into container B1, and the semi-liquid tomato into container B2. The meat is stewed in the lower pot, while the vegetables are cooked in the upper pot. The upper pot is filled with water, salt is added, and the vegetables are dumped from container B1. After the vegetables are cooked, the upper pot is filled with semi-liquid tomato from container B2. In the meantime, the meat has been stewed in the lower pot, as previously described. The upper pot empties the cooked vegetables and tomato onto the meat. Taste-enhancing spices are added, and the whole blend is cooked for some more time.

Sauces. Sauces consist of browned flour and supplements. Browned flour is made of butter and flour. Supplements include onions, garlic, parsley etc. As an example, we will describe how to make a white sauce with onions. The onions are cut into small pieces and quickly fried in oil. Then we add flour and fry some more. After that, we add milk, salt, pepper and let it cook.

In the machine, sauces are cooked in the lower pot. We will put butter into container B3, and onions into container B4. We will put milk into the container for liquid groceries. The butter is dropping from container B3 into the lower pot and it is heated. Onions are added from container B4. The onions are fried, and flour is added while the whisks are stirring. After the flour is fried, milk is added from container B5. Salt and pepper are added, and the blend is cooked for a short time.

Side dishes. Side dishes are sometimes cooked in column B. If soup is cooked in column A, and a stew in column C, then the side dish is cooked in column B. Usually, it is cooked potatoes. Potatoes cut into pieces are cooked in salt water.

We put the cut potatoes into container B1. The machine drops a specific amount of water and salt into the upper pot. Potatoes cut into pieces drop from container B1 into the upper pot. The potatoes are cooked. Once they are finished, the upper pot drops it into the lower pot, along with the liquid. The lower pot has a door, below which there are holes for the straining of the liquid. The door in the container opens and the water, inside which the potatoes were cooked, flows through the holes. The strained potatoes remain in the pot.

Fried meals. Frying pieces of mean or vegetables is performed using a larger amount of oil. We put the groceries we intend to fry into container B3. In the machine, the frying takes place in the lower pot. A large amount of oil is poured into the pot. It is heated well, upon which the contents of container B3 are emptied into it. The groceries (potatoes cut into pieces, pieces of meat etc.) are fried in hot oil.

In the follow-up, we will explain how to prepare characteristic meals in column C: vegetable stews, vegetable and meat stews, side dishes, fried and baked meals.

Vegetable stews. Vegetable stews consist of a stock sauce and cooked vegetables. The sauce consists of browned flour and water. Browned flour is made of oil and flour, as previously described. Onions and garlic are added, and water is poured over it. Vegetables are cooked in another pot. When the vegetables are finished, they are dropped into the browned flour. Spices are added and the blend is cooked for some more time.

The machine will cook the vegetable stew in the following way. To cook the vegetable stew, we need the following groceries: vegetables, onions, garlic, water, oil, flour, salt, and taste enhancing spices. We will put the vegetables into container C1. Should the vegetables we are about to cook have a somewhat larger volume (like cabbage, collard greens etc.), we will put it directly into the upper pot C6. We will put the onions into container C3, and garlic into container C4. Water and salt is poured into the upper pot. After that, vegetables are dropped from container C1. If the vegetables have a somewhat larger volume, it is already in the pot. The water is heated and the vegetables are cooking. Oil is poured into the lower pot C7, flour is added and fried, while the whisks are stirring. Onion is dumped from container C3, fried, and garlic is added after that. Water is added. After the sauce is finished, cooked vegetables are emptied from the upper pot into the lower pot. Spices are added and the blend is cooked for some more time.

Vegetable and meat stews. These stews are made from a variety of vegetables, with the addition of meat. Vegetables and meat cut into pieces are stacked directly into the pot, first the meat, and then the vegetables. Water and wine are added, and the blend is cooked.

The cooking method in the machine is as follows. The pot is turned and the lid of the pot opens. The user opens the lid of the machine and stacks the groceries directly into the pot. He closes the lid of the machine, upon which the pot returns to its starting position. The cooking is performed. After the meal is cooked, the pot is turned and the lid of the pot opens. The user takes the cooked meal directly out of the pot. This is the way to cook cabbage rolls and stuffed peppers.

Side dishes. Side dishes are also prepared in column C (pasta, rice meals, cooked potatoes etc.). Pasta is cooked in salted water. In the machine, the pasta should be put directly into the upper pot C6. After that, the machine adds water and salt to the pot. The pasta is cooking. Once it is cooked, the pot empties it into the lower pot. Aided by the door in the lower pot, the pasta is strained of the water in which it was cooked. The strained pasta remains in the lower pot. Rice is cooked in the lower pot, with occasional stirring of the whisks. Potatoes, cut into pieces, are put in container C1. It is cooked in water and salt in pot C6. Once it is cooked, it is emptied into the lower pot. It is also strained with the aid of the door in the lower pot.

Fried meals. As is the case with column B, groceries are also fried in column C in the previously described manner.

Baked meals. Baking of meat, for example, is also performed in column C. The baking is performed in the upper pot C6. Oil is poured into the pot and heated. After that, the pot turns and the lid of the pot opens. The user lifts the lid of the machine and puts the meat pieces into the pot. He closes the lid of the machine and the pot returns to its starting position. After a specified period of time, the pot turns again, and the user opens the lid of the machine and turns the meat to the other side. He closes the lid of the machine and the pot, once again, turns into the starting position. The other side of the meat is baked. Once it is baked, the user takes it out of the pot.

In the follow-up, we will explain the main components of the machine.

The case, FIG. 7, consists of two basic parts: the body of the case, 16, and the lid, 17. In the lid, there are containers that hold solid and semi-solid groceries, the liquid distributor, the water supply for the cooking water, the spice rotor, the cooling system and the steam exhaust system. The lid is lifted with the help of two bumpers fixed to the lid with one part, and to the body of the case with the other. On the upper part of the lid, 17, is a lid, 18, which closes all the food containers. In its upper part, the body of the case is divided into three compartments. One rotating pot is placed in each of these compartments. There is a funnel-shaped surface below each pot. In the middle of each of these three funnels is an opening, which leads towards the lower pots. Below the surface, where the rotor with the lower pots is moving, are the washing system devices. On the front side of the body of the case, there is a door, 19, through which the lower parts are removed from the device. In the middle part, as a part of the surface with the funnels, there is the door opening assembly of the lower pots. This is where all the three relays are.

The food containers, FIG. 8.1, are in the lid of the machine, 17. They are used for holding solid and semi-solid groceries. The upper openings of all containers are closed by a common lid, 18. Each container has a movable door on its lower opening, 20, FIG. 8.2. They are moved with the aid of an electric motor, a worm, 21, and a worm wheel, 22. Aside from the rotating function, the worm and worm wheel also have a self-springing function, i.e. when they are not rotating, they serve as a brake and keep the movable part in a fixed state. All movable parts in the device are rotated and blocked by the worm and the worm wheel. The doors are in a zero position when the container is closed. When the contents must be emptied, the doors open and the contents slide out of the container. In each column, there are containers, which are used to fill the upper pots, and containers, which are used to fill the lower pots. Each containers has a label, which consists of the column label and the container number, i.e. container C4. The patent application encompasses any version of the machine with any number of containers, and in all possible combinations.

The machine includes containers for liquid groceries, FIG. 9. They are used to fill the upper and lower pots with liquids. A number of these containers, 23, holds groceries which are permanently inside the machine (i.e. oil, vinegar), and they are periodically refilled (for example, each seven days). Other containers, 24, are used to apply liquid groceries on demand, depending on what meals are about to be cooked (for example, milk, wine, rum etc.). Each container has an electric valve at its lower end, which opens at the required moment and lets the contents of the containers out. For example, the amount of the liquid which will be left out of the container in cases of, for example, oil or vinegar, depends on the time interval during which the valve is open. The liquids are distributed (directed) towards the required upper or lower pot with the aid of the liquid distributor, which is placed below the container.

The liquid distributor, FIG. 10.1, is used to distribute the liquids towards the pots. Liquids from the containers and water from the water supply pass through the distributor. The liquid distributor consists of the rotational part, 25, and the the stator part, 26, FIG. 10.2. On the rotational part, there is an excentrically set bore, through which the liquids pass. Below the rotational part, on the stator part, there are bores which are continued into outlet pipes, that lead towards the upper and lower pots. Depending on the compartment above which the excentrical bore is set, the liquid will pass into a specific pot. The distributor can be executed in versions with four or six compartments. The basic version includes four compartments. Three of them are used to fill the upper three pots (labeled 1, 2 and 3 on FIG. 10.3), while one is used to fill all of the three lower pots (labeled 4). In that case, the rotor with the lower pots is set in a position, so that the lower pot, which we want to fill, arrives at the position of column B. For example, if we want to fill the lower pot of column A, the rotor will rotate for 180 degrees and come into the column B area. The liquid will be poured into the pot through the case opening of column B. The alternative version with six compartments has one compartment for each upper and lower pot, FIG. 10.4. In this case, it is required to rotate the lower pots for 60 degrees from the starting position, so that each pot will be below its case opening. In all further descriptions, we will stick to the basic version.

The spice rotor, FIG. 11.1, contains the spices, which have to be added into the pots during the preparation of the meals. It consists of a rotating container, 27, placed in the lid of the machine and the assembly of spice containers, 28 (labeled with 1-6 in the figure). The rotor rotates with the aid of the worm, 29, and thee worm wheel, 30, which are fixed to the rotating container. The assembly of spice containers is depicted on FIG. 11.2. Each of the containers in the assembly, 31, holds a single spice. The basic spices are salt, sugar, pepper, flour, red peppers and taste-enhancing spices. The containers are labeled with numbers and fit onto each other in a specific position. There are two band-shaped mounts fixed on the lowest container, which can be opened, 32. When the containers are piled up one on another, these bands are used to connect them into a whole. On the last container, there is a lid, which closes it, 33. There is a handle on the lid, 34, which the user uses to take the assembly out of the device. The containers are periodically removed from the device for a refill. Each container, FIG. 11.3, contains whisks, 35, which are moved by an electric motor placed in the lid of assembly 33. There are bores in the brim of each container. When they are piled into a unit, these bored act as pipes through which the spices are falling. There is an extension on each container, into which the whisk throws the spice while it rotates. Relay 36 is inside this extension, and below it is an opening through which the spice falls. The relay opens and closes the opening, which means that it functions as a vent and a dosage device. Relays on the containers, i.e. dosage devices, are placed so that there is a free pipe below them, through which the spices fall. The dosage devices on two adjacent containers are turned towards each other at angle of 60 degrees. The dosage of the spices is performed in the following manner. The dosage device starts, and its metal core rises and opens the opening in the container, FIG. 11.4. The whisks rotate inside the container and throw the spices into the extension, i.e. below the core of the dosage device. The dosage device shuts down, and its metal core lowers, pushing a specific amount of the spice down, FIG. 11.5. The dosage procedure is repeated as many times as needed, to throw the required amount of spice into a specific pot. On the lid of the case, below the rotor, FIG. 11.1, there are openings and slanting paths, through which the spices drop into pots. In the basic version, there are four openings, FIG. 11.6. Three of them are used to fill the upper pots (labeled 1, 2 and 3), while the fourth opening (labeled 4) is used to fill the lower pots. The lower pot that needs to be filled has to be set in the position of column B. This is achieved by the rotation of the rotor with the lower pots. When you want to fill one of the pots, the spice rotor rotates, so the pipe through which a specific pipe falls is positioned above the opening, which leads towards the pot that needs to be filled. The pot has to be open, if the upper one is filled, or set into the correct position, if the lower one is filled. The alternative version has six openings, FIG. 11.7. Three openings for the upper three pots (labeled 1, 2 and 3), and three openings for the lower three pots (labeled 4, 5 and 6). When the lower pots are to be filled, the rotor with the lower pots has to turn for 60 degrees from the starting position.

The upper movable pots are used for a partial or complete preparation of the meals, FIG. 12.1. The upper pot of column C is displayed on FIGS. 12.2 and 12.3. Each pot has two axles, 37, through which it is propped on the bearings, 38, placed on the sides of the case. The rotation of the pot is performed with the aid of the worm, 39, and the worm wheel, 40, which is placed on one of the pot's axles. Due to the self-springing characteristic of the worm and the worm wheel, the pot can be blocked at any angle position. At the bottom of the pot, there is an opening, and there is a semicircular movable lid, 42, above the opening. In the basic version, the opening of the lid is done with the aid of the pot's motion. There is a spring on each side of the movable lid, 43, and a limiter, 44. The springs push the limiters towards the elongated vertical parts of the bearings, 38, which are fixed to the case, 16. When the pot is in the vertical zero position, the lid fully closes the opening of the pot, FIG. 12.4. When the pot is rotated clockwise, FIG. 12.5, there is a relative counter-clockwise turning of the lid in respect to the pot. This is due to the fact that the distance between the limiter, 44, and the centre of the lid's rotation different from the distance between the limiter, 44, and the centre of the pot rotation. For example, if the pot rotates for 25 degrees, the lid will be relatively turned for 75 degrees in the opposite direction from the direction of the rotation of the pot. When the lid rotates for its maximum angle, i.e. the angle at which the opening of the pot is completely open, there are limiters on the pot, 45, which prevent further relative movement of the lid if there is any further rotation of the pot (i.e. when the contents of the pot are emptied). If the pot rotates counterclockwise, FIG. 12.6, the pot will relatively rotate clockwise. For example, when the pot rotates for −25 degrees, the lid will rotate for 75 degrees. When the pot returns to its zero position, the lid also returns to its starting position. Opening the pot in the alternative version can be done by opening the lid with two relays and two springs, FIG. 12.7. The springs, 46, push the lid towards the limiters, 47, which are placed on the pot. This is when the lid is in its zero position. When the lid needs to be opened, the relays, which pull the lid counterclockwise, are activated, FIG. 12.8. When the relays are shut down through the activity of the springs, the lid returns to its starting position. There is no need to rotate the pot in order to open the lid in this position. Also, an alternative version might have a pot without a lid. In that case, no rotation of the pot is needed during the filling of the pot with groceries. In the further text of the patent application, we will describe the basic construction version, i.e. a pot with a lid, which moves with the pot's rotation.

The rotor that bears the lower pots, FIG. 13, has the function of bearing and rotating the pots. It consists of the upper, 48, and lower part, 49, shaped like a star with three beams. In the middle part, there is an axle placed in the case bearings. At the bottom of the axle, there is a worm wheel, 50, paired with a worm, 51, which is used to realize the rotation of the rotor. At the lower end of the rotor, there are wheels which lean onto the surface of the case. Inside the case, there are three electric motors, which drive the whisks which are placed inside the pots, through a gear, 52. There are heating plates, 53, on the rotor, which are used to heat the pots. In the alternative version, the heating plates can be placed on the lower pots, instead of being on the rotor. The plates have a slit in the middle, because of the axles which are in the pots. The rotor is in its zero position when the beam of column A is in front of the front door of the machine. This is also the cooking position. The position where the lower pots are filled with groceries, or the upper pots are emptied, is when the rotor is rotated 60 degrees clockwise. When the lower pots are filled with spices or liquids, depending on the pot in question, the rotor assumes a position which is required to bring the pot that needs to be filled into the column B position. To fill pot A, the rotor will turn for 180 degrees. There is no rotation needed to fill pot B, and it will move for 300 degrees for pot C. When the machine is being washed, the rotor is successively turning from −60 to +60 degrees.

The lower pots have the function of partial or complete preparation of the food. Three lower pots, 54, fixed to the pot bearing rotor, are displayed on FIG. 14.1. On the lower part of the pots, there are pinouts shaped like the letter “L”. When they are on the rotor, the pot bottoms are on the heating plates, while the pinouts take hold of the edge of the rotor. This way, the pots are unable to move vertically. There are limiters on the rotor, down to which the pots can be pushed onto the rotor. In the back part of each pot, there is a small lever, 55, which the user lowers into the bore that is placed on the rotor, when the pot is pushed onto the rotor. This also blocks the pots from moving horizontally. The pots are removed from the rotor through the door in the case of the machine. At the sheet of the pot, there are two doors, which are covering the openings in the sheet of the pot, FIG. 14.2. Door number 1 (56) covers the holes in the sheet of the pot, through which the liquid leeks during the straining of the groceries (i.e. straining of the pasta). Door number 2 (57) covers the opening through which the warer and groceries leftovers leave the pot during the washing process. The door is pushed agains the sheet of the pot with the aid of springs, 58. The door is opened through the motion of the rotor, the relay on the case of the machine, and the small levers on the doors. The door opening principle will be explained later.

At the bottom of the pots, there are whisks, 59, which mix the groceries in the pot during the preparation of the food, FIG. 14.3. They are driven by the axle with the gear, 60, which gears with the gear on the rotor. At the top of the pot, there is a rubber gland, 61, which leans onto the surface of the case above the pot. When the rotor is in its starting position, i.e. the cooking position, this surface acts as the lid of the pot. In the column A pot, approximately at the ¾ of the surface of the pot's opening, there is an additional strain, 62, through which the contents that were cooked in the upper pot are strained, FIG. 14.4. During the straining, the meat and the vegetables remain on the strain, while the liquid falls into the pot. Close to the bottom of the strain, there is a circular vessel, through which the axle passes. Before cooking a soup with strained vegetables, additional whisks, 63, are placed on the axle. During the rotation, the whisks push the vegetables towards the sheet of the circular vessel. The softer part of the vegetables is pushed through the holes in the vessel, and this is how the straining is performed.

The door opening assembly on the pots consists of a case, 64, and three relays, 65, FIG. 14.5. There is one relay for each pot, which participates in the opening of door 1 and 2. If it is necessary to open door 1 on the pot of column A, the column A relay will be activated and its metal core will lower itself between the small levers on the door, FIG. 14.6. After the core has lowered itself, the rotor will turn for 60 degrees counterclockwise. By turning rotor, the small lever on the door will push against the core of the relay and the door will open, FIG. 14.7. When the rotor returns to its starting position, the door will close aided by the spring, which is placed on the pot. After that, the relay shuts down and the core withdraws. If door 2 needs to be opened, the procedure is repeated, with the exception that the rotor turns for 60 degrees clockwise. Door 2 is opened on all three pots on FIG. 14.8.

The control unit controls all the devices inside the machine. It can be done electronically, mechanically, or electromechanically. For each combination of three meals, a combination of two meals, or a single meal, there is algorhythm with an assigned number. This algorhythm contains the sequence of the basic operations, which began at an exact time, counting from the beginning of the cooking, and they also last for an exact period of time.

For each basic operation, there is a defined sequence of which deviced need to be activated at a certain moment. Basic operations are, for example, filling the pot A6 with the groceries from container A1, filling pot B7 with spice No. 3 etc. The control unit contains clocks, which measure how long individual operations last, the total cooking time, and the current time. Amounts of spice and water, the running of whisks, the operation of heating plates and other items are also defined by an algorhythm. Also, there is a display next to the keyboard, which displays instructions and information for the benefit of the user. The user enters the serial number of the meal's combination and other required information through the keyboard. By entering the serial number of the meal's combination and by starting the device, an algorhythm is activated, which is stored in the control unit. The user receives the serial numbers of meal combinations, i.e. algorhythms, and other necessary information, in a book, which is supplied along with the machine, and in the control unit itself.

For each meal of an individual combination, there are various informations supplied in the book: which groceries and amounts are required to be placed in a specific container, or directly into a specific pot. The user uses a scale to measure the amount of solid foods. For liquid foods, he uses vessels with labeled measures. Also, he receives several knives with limiters, along with the machine. One knife is used for cutting the meat, the second for onions, the third for vegetables etc. Limiters are used so that each food would always be cut to the same length. When the user cuts the groceries and puts them into the containers or pots, he needs to enter some data with the keyboard before he starts the device. First and foremost, he needs to enter the serial number of the meal combination. Then he enters the number of persons for which the meals are to be cooked (1, 2, 3, 4 etc.), which is important for the machine to apply the correct spice dosage and the dosage of those grocery it adds by itself. The user can correct individual parameters through the keyboard, like the amount of spices, the duration of individual operations etc. He also enters the time when the machine is about to begin the cooking process. The options for this are: immediate start of cooking, a delay of several minutes, and a delay of several hours. When the desired delay is several hours, the cooling system of the food containers is activated, so the groceries in the containers wouldn't rot before the cooking starts.

The cooling system consists of the cooling unit, 65, and the ventilator, 66, which circulates cold air around the containers with groceries, FIG. 15.

The steam exhaust system consists of a pipe, 67, and a ventilator, 68, which draws the steam out of the machine (the steam which is created during cooking or washing), FIG. 16.

After the cooking, the machine is washed by the washing system. The washing system consists of a water supply, electric valve, heater, detergent container, piping and openings on the surfaces of the case, through which the washing liquid is injected, FIG. 17. The water is supplied from the waterworks. During the washing phases, the doors of the food containers are open. The upper parts are rotated for 180 degrees, while the rotor with the lower pots successively rotates from −60 to +60 degrees. At the same time, all three relays of the door opening assembly, are activated, which ensure the successive opening of doors 1 and 2 on all lower pots. After the washing, the washing liquid is drained through the water outlet.

The invention's primary purpose is the use in households, which consist of one or more persons.

1. Machine for preparing food is characterized by the fact that it consists of a case, containers for solid and semi-solid groceries, containers for liquid groceries, a water supply with a heater, a liquid distributor, a spice rotor, three rotating upper pots with heating plates, a rotor with a heating plate, which carries the lower pots, a control unit, a water drain, a cooling system, a steam exhaust system and a machine washing system,
that it contains three so-called columns, that each column is used to cook one meal, that, in the basic version of the machine, each column includes containers for solid and semi-solid groceries, one or more containers for liquid groceries, one rotating upper pot and one lower pot placed on a rotor, that the common parts for all three columns are the spice rotor, the liquid grocery containers which have to be periodically refilled (with oil, vinegar etc.), a water supply and a liquid distributor, that, with their aid, all upper and lower pots are filled with spices, oil, vinegar and water, and that the rotor which carries the lower pots is also common for all columns, and that the machine can be constructed with a different number of pots,
that the case of the machine consists of two separate parts, the body of the case and the lid, that there are three compartments inside the body, where the upper pots are placed, that there are funnel-shaped surfaces below the pots, as a part of the case, and that there are holes in their centres, that there is a space below these surfaces, where the lower pots with the rotor are placed, that there are surfaces below this rotor, which close the lower part of the case, that there are doors on the front part of the body of the case, that there are containers for solid and semi-solid groceries in the lid, as well as the liquid distributor, spice rotor and other integral parts, that there is a lid to close the groceries' containers in the upper part,
that the containers for solid and semi-solid groceries are placed in the lid of the machine, that they are closed on the top side by a lid, and that they have movable doors on the bottom sude, that some containers are used to fill the upper pots with groceries, and others are used to fill the lower pots with groceries,
that some liquid groceries containers are used for liquid groceries which are permanently inside the machine (oil, vinegar etc.), while others are used to be filled on demand, that there is a valve at the bottom of each container, that the liquids are directed towards the pots with the aid of liquid distributors and pipes, which lead towards the upper and lower pots,
that the spice rotors is used to fill all the pots with spices, that the assembly of the containers is removed from the machine to be refilled with spices, that there is a dosage device in each container to dose the amount of spices, that there is a pipe below each dosage device, through which the spices are falling, that there are openings below the rotor, which lead towards the pots, that the rotor rotates while the spices are being filled into the pot, and that it assumes a position in which the pipe, through which the spice falls, arrives above the opening that leads to the required pot,
that the upper pots lean onto the case through the axles, that there is a pot rotating mechanism attached to one axle, i.e. spindle of each pot, that there is an option to block them in the desired angle position, that the pots have a heating plate attached to their bottoms, that they have an opening on the upper end, on which there is a movable lid, that the pots can be made without lids,
that the rotor, which carries the lower pots, has three beams on which the three lower pots are placed, that the rotor leans to the case through wheels located at the brim of the rotor, that there is an axle in the middle of the rotor, which is used to rotate the rotor, that the rotor rotates and blocks in the desired angle position, with the aud of a rotating mechanism connected to the axle of the rotor, that there are three heating plates on the rotor, that these plates can be placed on the lower pots instead of being placed on the rotor, that there are driver gears on the rotor, which are used to run the whisks in the lower pots,
that the lower pots are placed on the beams of the rotor, that there are whisks inside each pot, which are used to mix the groceries, that there are two movable doors on the sheet of each pot, which are opened with the aid of a door opening assembly, that there is an opening below a door, and that there are holes below the other door, through which the water exits during straining, that there is a strainer in the lower pot of column A, at approximately ¾ of the pot's opening, through which the contents of the upper pot are strained, that there is another whisk in the strainer, used to run the groceries through the strainer, that the pots are removed from the machine through the front door on the case of the machine,
that there is a control unit in the machine, which controls all the devices in the machine. that there is a keyboard connected to the control unit, and a display, through which the user enters the required information, and receives feedback from the machine, that the control unit controls the devices through algorhythms, in which there are required informations about the sequence of the basic operations, the duration of individual operations, the amount of spices, the activity of the whisks, the activity of the plates etc., that there is a separate numbered algorhythm for each combination of three meals, two meals or a single meal,
that the working principle consists of the following: along with the machine, the user receives instructions where the meal combinations are numbered, that for each meal, the required amounts of groceries are noted, as well as the containers and pots where they have to be put in, that, after the user picks the combination of the meal through the keyboard, and it can be a combination of three meals, two meals or a single meal, he puts cut solid and semi-solid groceries into the groceries' containers, or, if the groceries in question are of a bigger volume, directly into the upper and lower pots, that he also supplies liquid groceries into their respective containers, that the spices, oil and vinegar are inside the machine and that the user periodically refills them, that the water is supplied from the water supply, or the user refills it by himself, that the user can put the groceries several hours before the beginning of the cooking, because the machine has a cooling system, which prevents the rotting of the groceries, that the operations of food preparing are performed after the groceries have been put inside and the machine was started, that the control unit controls all the devices inside the machine according to an algorhythm, that there is a separate algorhythm for each meal combination, which contains all the information the machine requires to make a meal, a sequence of basic operations, a duration of the opeations, the amount of spices, the operation of the heating plates, the operation of the whisks, etc., that the preparing of the meal is performed in a way that the liquid groceries, spices, solid and semi-solid groceries are put into the machine according to a given algorhythm at a precisely defined time, that the groceries are thermally processed in the pots for a defined period of time, that there are simple and complex meals, where simple meals consist of a smaller number of groceries and can be prepared in a single upper or lower pot, while for complex meals, one part is thermally processed in the upper pot, while the other is prepared in the lower pot, usually with the stirring of the rotating whisks, since the upper pot can rotate after the thermal processing is finished, the pot rotates and its contents are emptied into the lower pot, the contents of the two pots mix, spices are added and additional thermal processing is applied, which results in a complete meal, during the whole process the steam exhaust system is active, and after the process is finished, the user removes the lower pots with the finished meals out of the machine, or takes the finished meals out of the upper pots, and, after all the meals are taken from the machine, the user starts the machine washing operation, and after the washing process, the machine is ready for a new cooking cycle.
